(19) United States
(12) Patent Application Publication
(10) Pub. No.: US 2014/0315496 A1
(43) Pub. Date: Oct. 23, 2014

(54) WIRELESS QUALITY COLLECTING DEVICE, WIRELESS QUALITY COLLECTING METHOD, AND COMPUTER-READABLE RECORDING MEDIUM

(71) Applicant: FUJITSU LIMITED, Kawasaki-shi (JP)

(72) Inventor: Yutaka Hamada, Yokosuka (JP)

(73) Assignee: FUJITSU LIMITED, Kawasaki-shi (JP)

(21) Appl. No.: 14/223,388

(22) Filed: Mar. 24, 2014

(30) Foreign Application Priority Data
Apr. 17, 2013 (JP) 2013-086846

(51) Int. Cl. H04W 24/08

(52) U.S. Cl. CPC H04W 24/08
USPC 455/67.11

(57) ABSTRACT

A wireless quality collecting device receives quality information on a wireless area from a terminal device that is located in the wireless area. For each region belonging to a predetermined range, the wireless quality collecting device counts the number of pieces of the received quality information. For a region in which the total number of pieces of the counted quality information is equal to or greater than a predetermined number, from among pieces of the quality information belonging to the region, the wireless quality collecting device selects the predetermined number of pieces of the quality information and stores the selected quality information in a storing unit.

### CROSS-REFERENCE TO RELATED APPLICATION

This application is based upon and claims the benefit of priority of the prior Japanese Patent Application No. 2013-086846, filed on Apr. 17, 2013, the entire contents of which are incorporated herein by reference.

### FIELD

The embodiments discussed herein are directed to a wireless quality collecting device, a wireless quality collecting method, and a wireless quality collecting program.

### BACKGROUND

Multiple companies construct mobile phone systems and provide various services. The state of wireless areas formed by both wireless base stations and terminal devices vary due to the time or locations. Consequently, the communication state in the wireless areas are improved by measuring the wireless quality in each of the wireless areas.

In general, a high-cost drive test is used for this measurement. In recent years, the Minimization of Drive Test (MDT) technology is used as a method of reducing the cost. The MDT technology measures the wireless quality in a wireless area by using a terminal device owned by a user in this area and automatically reports the measurement result to an operator. The pieces of quality information collected from terminal devices in this way are registered in databases in the companies that provide the mobile phone systems and are used to develop the quality.

Furthermore, there is a known technology, as a technology for changing the collecting period of the wireless quality, that changes a collecting period depending on the accuracy of location information on a terminal device that corrects the quality information. Furthermore, there is a known technology that changes a collecting period in accordance with the time intervals for which a terminal device collects information or in accordance with the state of a battery in the terminal device.
Patent Document 1: Japanese Laid-open Patent Publication No. 2012-029053
Patent Document 2: Japanese Laid-open Patent Publication No. 2012-085235
Patent Document 3: Japanese Laid-open Patent Publication No. 2011-223118

However, with the technologies described above, if, for example, a wireless area collected by a person has occurred, quality information is excessively collected and thus the size of a storage device that stores therein the quality information collected from the terminal device becomes enlarged. Consequently, there is a problem in that the capital investment in improving the wireless quality is excessively increased.

### SUMMARY

According to an aspect of the embodiment, a wireless quality collecting device includes a memory; and a processor coupled to the memory, wherein the processor executes a process. The process includes receiving quality information on a wireless area from a terminal device that is located in the wireless area; counting, for each region belonging to a predetermined range, the number of pieces of the quality information received at the receiving; and selecting, for a region in which the total number of pieces of the quality information counted at the counting is equal to or greater than a predetermined number, from among pieces of the quality information belonging to the region, the predetermined number of pieces of the quality information and storing, in the memory, the selected quality information.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a schematic diagram illustrating an example of the overall configuration of a wireless communication system according to a first embodiment;

FIG. 2 is a block diagram illustrating the configuration of a terminal device according to the first embodiment;

FIG. 3 is a block diagram illustrating the configuration of a wireless quality collecting device according to the first embodiment;

FIG. 4 is a schematic diagram illustrating a process performed by the wireless quality collecting device according to the first embodiment;

FIG. 5 is a schematic diagram illustrating an example of measurement data received by the wireless quality collecting device;

FIG. 6 is a schematic diagram illustrating an example in which the wireless quality collecting device classifies the measurement data by region;

FIG. 7 is a schematic diagram illustrating an example in which the wireless quality collecting device counts the number of pieces of measurement data for each region;

FIG. 8 is a flowchart illustrating the flow of a store control process performed by the wireless quality collecting device according to the first embodiment;

FIG. 9 is a processing sequence diagram of a process performed by a wireless communication system according to the first embodiment; and

FIG. 10 is a schematic diagram illustrating a process performed by the wireless communication system according to the first embodiment.

### DESCRIPTION OF EMBODIMENTS

Preferred embodiments will be explained with reference to accompanying drawings. The present invention is not limited to these embodiments.

### [a] First Embodiment

### Overall Configuration

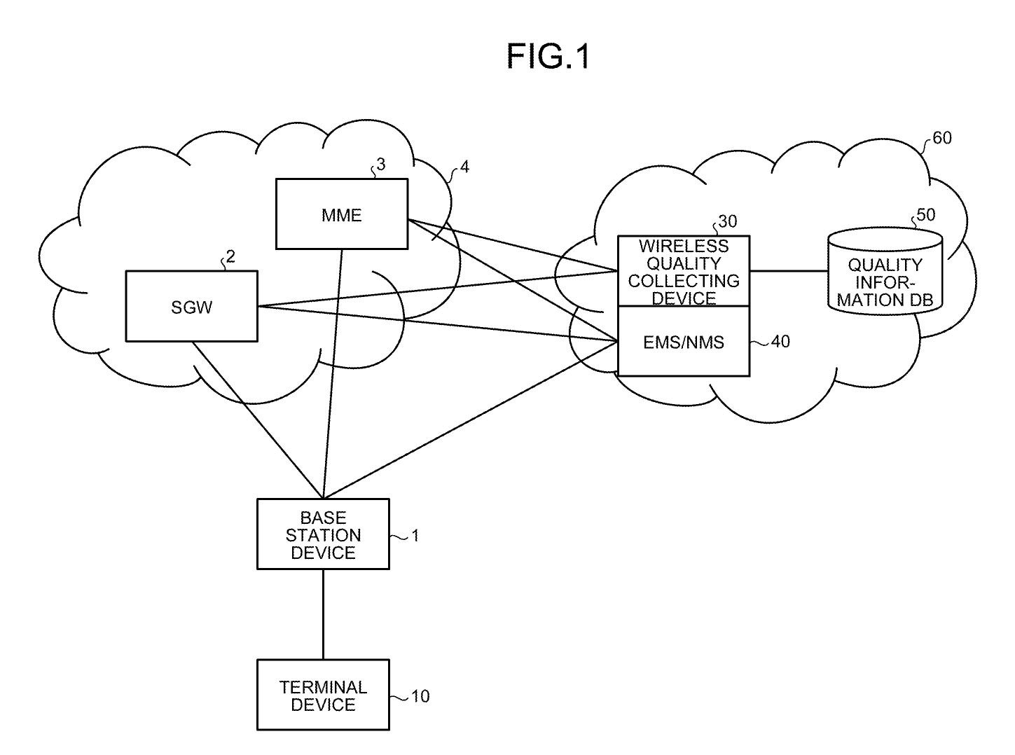

FIG. 1 is a schematic diagram illustrating an example of the overall configuration of a wireless communication system according to a first embodiment. As illustrated in FIG. 1, the wireless communication system includes a base station device 1, a terminal device 10, a core network 4, and a supervisory control network 60.

The base station device 1 is a device that manages a predetermined wireless area and that communicates with the terminal device 10 that is located in a wireless area. The terminal device 10 is a device that communication with the other terminal devices via the base station device 1 and is, for example, a mobile phone or a smart phone.

The core network 4 is a network constituted by, for example, a serving gateway (SGW) 2 or a mobility management entity (MME) 3. The SGW 2 is a relay device that accommodates, for example, Long Term Evolution (LTE) or a Third Generation Partnership Project (3GPP) radio and that routes user data or the like. The MME 3 is an access gateway that relays control data.

The supervisory control network 60 is a network that performs supervisory control of the terminal device 10 and that is constituted by a wireless quality collecting device 30, an Element Management Systems (EMS)/Network Management Systems (NMS) 40, a quality information database (DB) 50, and the like.

The wireless quality collecting device 30 is a server device that collects, from the terminal device 10 via the base station device 1, quality information on a wireless area. The EMS/NMS 40 is a server device that manages the entire network. For example, the EMS/NMS 40 manages the terminal device 10 via the base station device 1. The quality information DB 50 is, for example, a database server that stores therein the quality information collected from the terminal device 10. The information stored in the quality information DB 50 is used to improve the quality of radio.

With this configuration, the wireless quality collecting device 30 receives quality information on a wireless area from the terminal device 10 that is located in the wireless area. Then, the wireless quality collecting device 30 counts the number of pieces of received quality information for each region belonging to a predetermined range. Then, for a region in which the total number of pieces of the counted quality information is greater than a predetermined number, the wireless quality collecting device 30 selects, from among the pieces of the quality information belonging to the region, the predetermined number of pieces of the quality information and then stores the selected information in the quality information DB 50.

As described above, the wireless quality collecting device 30 can receive quality information on wireless areas from the terminal device 10, thin out some pieces of quality information that have already been received for a wireless area in which terminal devices are concentrated, and then register the remaining quality information in the quality information DB 50. Consequently, the wireless quality collecting device 30 can suppress enlargement of the quality information DB 50 and thus can suppress the capital investment in improving the wireless quality.

Configuration of Each Device

In the following, the configuration of each of the devices illustrated in FIG. 1 will be described. The SGW 2 has the same configuration as that performed by a typical SGW, the MME 3 has the same configuration as that performed by a typical MME, and the base station device 1 has the same configuration as that performed by a typical base station; therefore, descriptions thereof in detail will be omitted. Furthermore, the EMS/NMS 40 has the same configuration as that performed by a typical server device or the like, the quality information DB 50 has the same configuration as that performed by a typical database or a typical database server; therefore, descriptions thereof in detail will be omitted. In the first embodiment, the terminal device 10 and the wireless quality collecting device 30 will be described.

Configuration of a Terminal Device

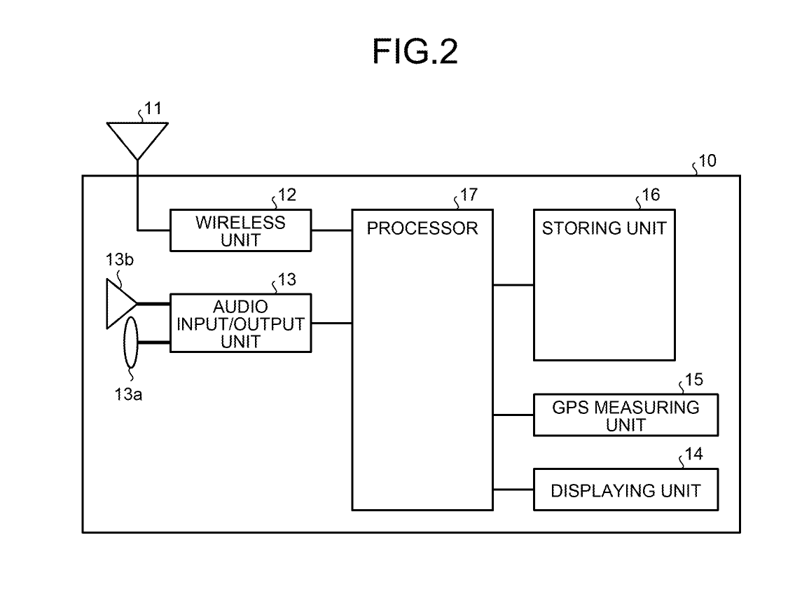

FIG. 2 is a block diagram illustrating the configuration of a terminal device according to the first embodiment. As illustrated in FIG. 2, the terminal device 10 includes an antenna 11, a wireless unit 12, an audio input/output unit 13, a displaying unit 14, a global positioning system (GPS) measuring unit 15, a storing unit 16, and a processor 17. The hardware configuration illustrated in FIG. 2 is only an example. Another piece of hardware, such as a short distance wireless unit, may also be included.

The antenna 11 is an example of a sending/receiving device that sends and receives radio signals containing therein, for example, various kinds of data or the like. The wireless unit 12 is an example of a communication central processing unit (CCPU) or the like that executes wireless communication via the antenna 11. For example, the wireless unit 12 receives a signal via the antenna 11 and then outputs the received signal to the processor 17. Furthermore, the wireless unit 12 sends, via the antenna 11, a signal created by the processor 17. If the wireless unit 12 is, for example, a mobile phone with which the terminal device 10 can communicate, the wireless unit 12 sends and receives a signal containing therein, for example, user's output voice or received voice.

The audio input/output unit 13 is an example of input/output interface that collects voices or that outputs voices. For example, the audio input/output unit 13 performs an audio process on audio sounds collected by a microphone 13a, performs the audio process on an audio signal included in a radio signal that is received via the wireless unit 12, and then outputs the sounds from a speaker 13b.

The displaying unit 14 is an example of a display or a touch panel that displays various kinds of information. For example, the displaying unit 14 displays, on a screen, an application executed by the processor 17 or information on, for example, an outgoing call or an incoming call. The GPS measuring unit 15 is a measuring instrument that communicates with a GPS satellite and measures the current position.

The storing unit 16 is a storage device that stores therein data or various programs used to execute various functions performed by the terminal device 10. An example of the storing unit 16 includes a read only memory (ROM), a random access memory (RAM), a hard disk, or the like.

The processor 17 executes the overall control of the terminal device 10 by using a program or data stored in a ROM or a RAM in the storing unit 16. An example of the processor 17 includes a central processing unit (CPU), a micro processing unit (MPU), or the like.

The processor 17 loads, in the RAM, the program that is stored in the ROM or the like and then executes various processes associated with various tasks. In the following, a description will be given of a specific example of a process executed by the processor 17. The processor 17 executes a typical process executed by the terminal device 10; however, the process will be omitted here. Examples of the typical process include a Web process, a mail sending/receiving process, an execution process performed on various applications, such as a game, SNS, or the like, and a download or install process performed on an application.

Measurement Process of the Wireless Quality

The processor 17 measures, at a predetermined timing, the quality of a wireless area in which the terminal device 10 is located. Specifically, the processor 17 measures the quality of a wireless area, by using a signal that is always sent by the base station device 1, at a measuring period that is notified by the wireless quality collecting device 30 via the EMS/NMS 40.

For example, the processor 17 measures the quality of the wireless area on the basis of, for example, the level of the pilot channel sent from the base station device 1 or the ratio of a signal sent from the base station device 1 to noise at the time of the reception of the signal.

Measuring Process Performed on Location Information

The processor 17 measures location information on the terminal device 10 by using the GPS measuring unit 15. For example, when the wireless quality has been measured, the processor 17 acquires the location information measured by the GPS measuring unit 15 and then specifies the location information on the location where the wireless quality has been measured.

Sending Process Performed on Measurement Data

The processor 17 sends the quality information on the wireless area to the wireless quality collecting device 30. For example, when the measurement of the wireless quality and the location information has been completed, the processor 17 sends, to the wireless quality collecting device 30, measurement data that includes the measured quality information and the measured location information. The measurement data that is sent at this point includes, for example, the terminal ID that is used to identify the terminal device 10 and the measurement time at which the wireless quality has been measured.

Configuration of the Wireless Quality Collecting Device

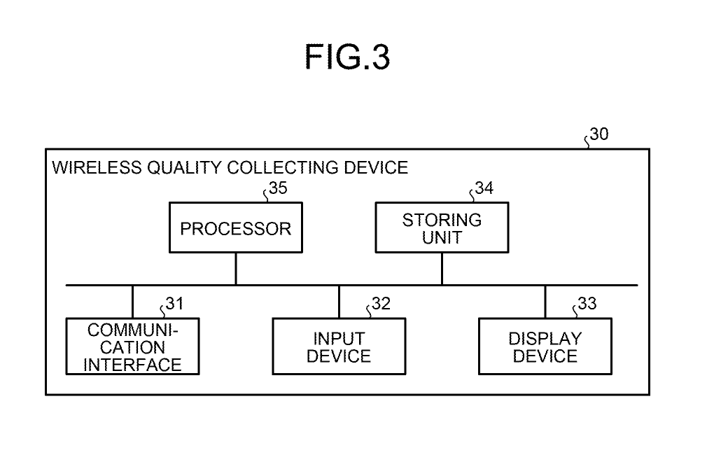

FIG. 3 is a block diagram illustrating the configuration of a wireless quality collecting device according to the first embodiment. As illustrated in FIG. 3, the wireless quality collecting device 30 includes a communication interface 31, an input device 32, a display device 33, a storing unit 34, and a processor 35. The hardware configuration illustrated in FIG. 3 is only an example and another hardware may also be included.

The communication interface 31 is an interface, such as a network interface card or a wireless interface, that sends and receives data to and from the base station device 1, the SGW 2, the MME 3, the EMS/NMS 40, the quality information DB 50, or the like.

The input device 32 is a device, such as a mouse or a keyboard, that receives an input from a user or the like. The display device 33 is, for example, a display or a touch panel that displays various kinds of information.

The storing unit 34 is a storage device that stores therein data or various programs used to execute various functions that are performed by the wireless quality collecting device 30. Examples of the storing unit 34 include a ROM, a RAM, a hard disk, or the like.

The processor 35 executes the overall control of the wireless quality collecting device 30 by using a program or data stored in a ROM or a RAM in the storing unit 34. An example of the processor 35 includes a CPU or a MPU. The processor 35 loads, in the RAM, the program that is stored in the ROM or the like and then executes various processes associated with various tasks.

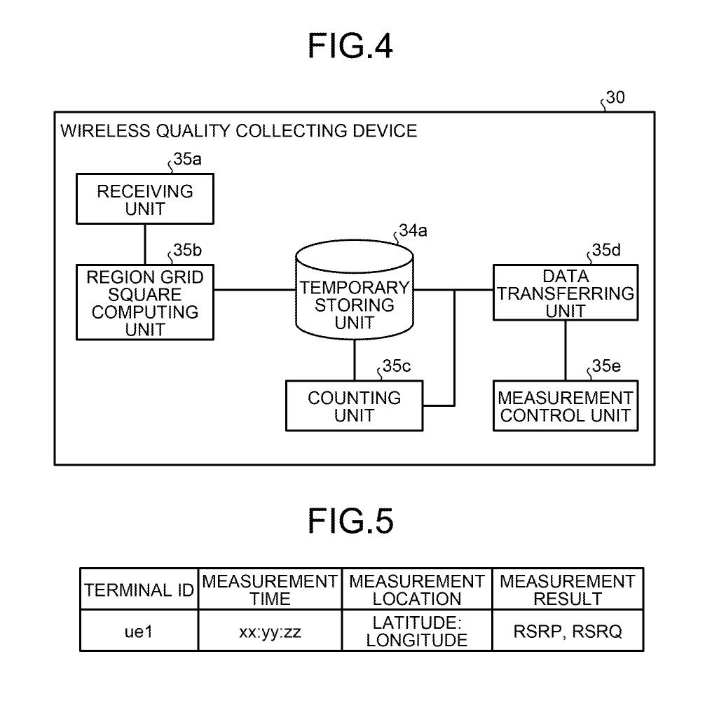

In the following, a description will be given of a process executed by the processor 35. FIG. 4 is a schematic diagram illustrating a process performed by the wireless quality collecting device according to the first embodiment. The wireless quality collecting device 30 executes a receiving unit 35a, a region grid square computing unit 35b, a counting unit 35c, a data transferring unit 35d, a measurement control unit 35e, and a temporary storing unit 34a.

The receiving unit 35a, the region grid square computing unit 35b, the counting unit 35c, the data transferring unit 35d, and the measurement control unit 35e are processing units executed by the processor 35. The temporary storing unit 34a is data area included in the storing unit 34. Each of the processing units may also be configured by hardware, such as a circuit or the like.

The receiving unit 35a is a processing unit that receives measurement data from the terminal device 10 via the base station device 1. Specifically, the receiving unit 35a receives, from each base station device 1, quality information on a wireless area measured by the terminal device 10 located in a wireless area managed by each corresponding base station device 1. FIG. 5 is a schematic diagram illustrating an example of measurement data received by the wireless quality collecting device.

As illustrated in FIG. 5, the measurement data stores therein, in an associated manner, the “terminal ID”, the “measurement time”, the “measurement location”, and the “measurement result”. The “terminal ID” mentioned here means an identifier that identifies the terminal device 10 that has measured the wireless quality. The “measurement time” is the time at which the wireless quality has been measured. The “measurement location” is the location where the wireless quality has been measured and is, for example, the latitude and the longitude. The “measurement result” indicates the measured wireless quality.

The example illustrated in FIG. 5 indicates the measurement result measured by the terminal device 10 with the terminal ID of “ue1” at the time indicated by “xx:yy:zz” at the location indicated by “latitude:longitude”. Examples of the measurement result include reference signal received power (RSRP) that is the linear average value of downlink reference signals in the entire channel bandwidths measured in the physical layer of an LTE terminal device, a reference signal received quality (RSRQ) that is the quality index of an LTE signal, or the like.

The region grid square computing unit 35b is a processing unit that checks the latitude and the longitude from the measurement data received by the receiving unit 35a and that calculates the measured region code. Then, the region grid square computing unit 35b attaches a region code to each piece of the measurement data received by the receiving unit 35a and then stores the data in the temporary storing unit 34a. Alternatively, the region grid square computing unit 35b attaches a region code to each piece of measurement data that is received by the receiving unit 35a and that is stored in the temporary storing unit 34a. Furthermore, the region grid square computing unit 35b notifies the counting unit 35c that the region code has been attached to each piece of measurement data.

For example, on the basis of the information on the latitude and the longitude included in the measurement data, the region grid square computing unit 35b creates a region grid square code, i.e., JIS X 0410, conforming to Japanese industrial standards. Then, the region grid square computing unit 35b attaches a region grid square code to the measurement data and stores the data in the temporary storing unit 34a. Specifically, if the latitude is 35.2834 and the longitude is 139.6561, the region grid square computing unit 35b calculates a three-dimensional grid square code of 5239-7542 as a region grid square code.

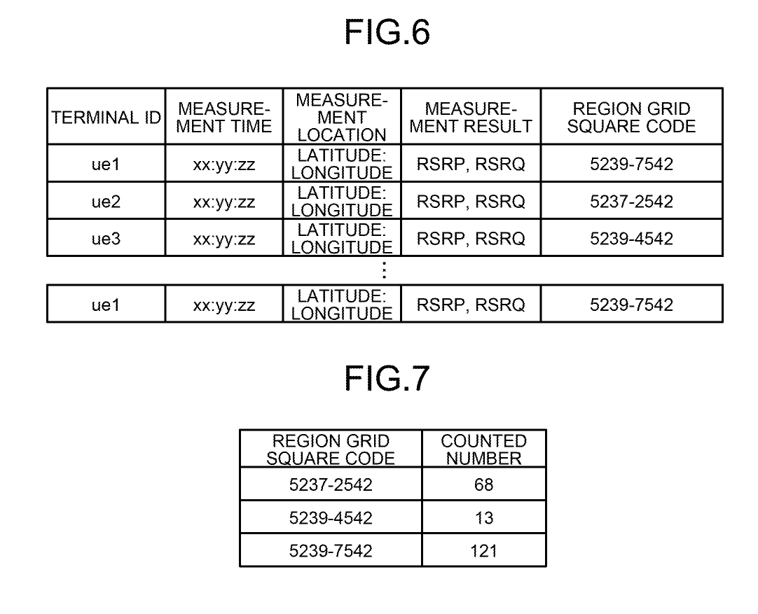

The “region grid square code” created at this point is information by which a region belonging to a predetermined range can be identified and which indicates a wireless area located at, for example, a radius of about 30 km of the base station device 1. FIG. 6 is a schematic diagram illustrating an example in which the wireless quality collecting device classifies the measurement data by region. The information illustrated in FIG. 6 is stored in the temporary storing unit 34a.

As illustrated in FIG. 6, the temporary storing unit 34a stores therein measurement data that includes the “terminal ID”, the “measurement time”, the “measurement location”, the “measurement result”, and the “region grid square code”. The “terminal ID”, the “measurement time”, the “measurement location”, and the “measurement result” are the measurement data sent from the terminal device 10 and the “region grid square code” is a region code calculated by the region grid square computing unit 35b. The example illustrated in FIG. 6 indicates that the region grid square code “5239-7542” is attached to the measurement data that has been measured by the terminal device 10 with the terminal ID of “ue1” at the time indicated by “xx:yy:zz” at the location indicated by “latitude:longitude”.

The counting unit 35c is a processing unit that counts the number of pieces of measurement data for each region that belongs to a predetermined range. Specifically, the counting unit 35c refers to the “region grid square code” of each piece of the measurement data stored in the temporary storing unit 34a and counts the number of pieces of the measurement data to which the same “region grid square code” is attached.

In the example illustrated in FIG. 6, the counting unit 35c reads the region grid square code “5239-7542” at the top measurement data and counts the number of pieces of the measurement data to which this region grid square code “5239-7542” is attached. Then, the counting unit 35c refers to the measurement data, reads the region grid square code that has not been counted, and then counts the number of pieces of the measurement data that has the read region grid square code.

FIG. 7 is a schematic diagram illustrating an example in which the wireless quality collecting device counts the number of pieces of the measurement data for each region. The information illustrated in FIG. 7 is temporarily stored in, for example, the storing unit 34. As illustrated in FIG. 7, the counting unit 35c counts the number of pieces of the measurement data to which the region grid square code “5237-2542” is attached is “68” and counts the number of pieces of the measurement data to which the region grid square code “5239-4542” is attached is “13”. Furthermore, the counting unit 35c counts the number of pieces of the measurement data to which the region grid square code “5239-7542” is attached to is “121”.

In other words, the example illustrated in FIG. 7 indicates that 68 pieces of measurement data have been received from the wireless area that is specified by the region grid square code “5237-2542”; indicates that 13 pieces of measurement data have been received from the wireless area specified by the region grid square code “5239-4542”; and indicates that 121 pieces of measurement data have been received from the wireless area specified by the region grid square code “5239-7542”.

For the region in which the total number of pieces of measurement data counted by the counting unit 35c is equal to or greater than a predetermined number, the data transferring unit 35d is a processing unit that selects a predetermined number of pieces of measurement data from among the measurement data belonging to the region and stores the data in the quality information DB 50. Specifically, for the wireless area in which the number of pieces of collected measurement data exceeds a threshold, the data transferring unit 35d thins out some pieces of measurement data and then transfers the remaining measurement data to the quality information DB 50.

For example, for the result of the counted measurement data to which a region grid square code is attached, the data transferring unit 35d determines to store a value of an integer part obtained by dividing the result of the counting by a threshold. Then, the data transferring unit 35d selects the measurement data of the number of the determined integer value from the temporary storing unit 34a and transfers the selected measurement data to the quality information DB 50.

In the example illustrated in FIG. 7, for the measurement data with the region grid square code “5239-7542”, the data transferring unit 35d divides the counted number “121” by the threshold “15” to obtain the calculation result, i.e., “121/15=8.066 . . . ”. Then, for the measurement data with the region grid square code “5239-7542”, the data transferring unit 35d stores data once in every nine times.

Specifically, the data transferring unit 35d reads a first data with the region grid square code “5239-7542” from the temporary storing unit 34a and transfers the data to the quality information DB 50. Then, for the second to the eighth data, the data transferring unit 35d reads the data from the temporary storing unit 34a and deletes the data. Thereafter, the data transferring unit 35d reads, from the temporary storing unit 34a, the ninth data with the region grid square code “5239-7542” and transfers the data to the quality information DB 50. The order of the data, such as the first data, is, for example, the order the data sequentially stored in the temporary storing unit 34a or the chronological order of the measurement time.

Furthermore, the data transferring unit 35d can use various methods for thinning out the data. For example, for the measurement data with the region grid square code “5239-7542”, the data transferring unit 35d may also select, from among the pieces of target measurement data stored in the temporary storing unit 34a, nine pieces of data from among the pieces of data that have been measured at the latest measurement time.

The measurement control unit 35e is a processing unit that changes a collecting period, which is used for quality information and is set in the terminal device 10 that is located in a region in which the total number of pieces of measurement data is equal to or greater than a predetermined number, to a period longer than that currently set. Furthermore, the measurement control unit 35e is a processing unit that changes a collecting period, which is used for quality information and is set in the terminal device 10 that is located in a region in which the total number of pieces of measurement data is equal to or less than the lower limit, to a period shorter than that currently set.

Specifically, for a region in which the terminal devices 10 are concentrated, the measurement control unit 35e changes the period in which measurement data is sent to a long period, so that the measurement control unit 35e prevents measurement data from being concentrated and furthermore reduces the waste of network bandwidths. Furthermore, for a region in which a small number of terminal devices 10 is present, the measurement control unit 35e changes the period in which measurement data is sent to a short period, so that the measurement control unit 35e collects pieces of measurement data in a concentrated manner and thus suppresses a decrease in the accuracy due to an insufficient number of pieces of data.

For example, the measurement control unit 35e changes the period to a period calculated by using the formula “counted number/threshold×current set period”. In the example of the region grid square code “5237-2542” illustrated in FIG. 7, the measurement control unit 35e calculates a period of “68 (pieces)/15×10 (s)=45.3333”. Consequently, the measurement control unit 35e sends an instruction to change the measurement period to “45 (s)” to the base station device 1 that manages, as a wireless area, the “latitude:longitude” that is associated with the region grid square code “5237-2542”.

For another example, for the region grid square code “5239-4542” illustrated in FIG. 7, the measurement control unit 35e calculates a period of “13 (pieces)/15×10 (s)=8.6666 . . . ”. Consequently, the measurement control unit 35e sends an instruction to change the measuring period to a measuring period of “8 (s)” to the base station device 1 that manages, as a wireless area, “latitude:longitude” associated with the region grid square code “5239-4542”.

Flow of the Store Control Process

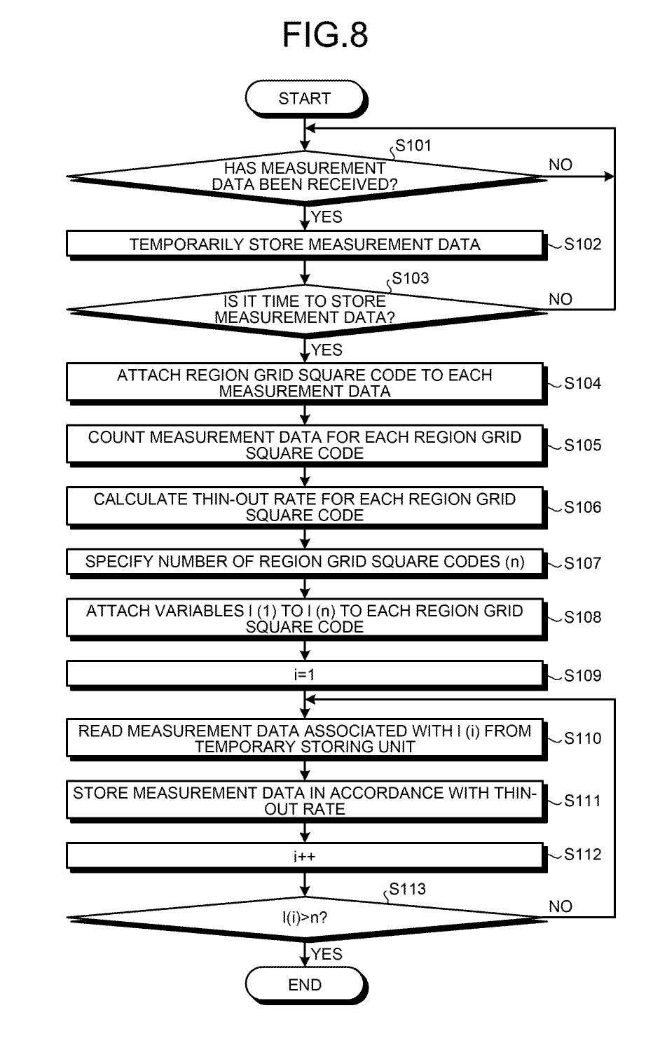

FIG. 8 is a flowchart illustrating the flow of a store control process performed by the wireless quality collecting device according to the first embodiment. As illustrated in FIG. 8, when the receiving unit 35a in the wireless quality collecting device 30 receives measurement data (Yes at Step S101), the receiving unit 35a stores the received measurement data in the temporary storing unit 34a (Step S102).

The receiving unit 35a repeatedly performs the processes at Steps S101 and S102 until, as a trigger, the measurement data is stored in the quality information DB (No at Step S103).

When the measurement data is to be stored in the quality information DB 50 (Yes at Step S103), the region grid square computing unit 35b calculates a region grid square code for each measurement data stored in the temporary storing unit 34a and attaches the region grid square code to each measurement data (Step S104).

Subsequently, the counting unit 35c counts the number of pieces of measurement data for each region grid square code (Step S105). Then, by using the result of the counting, the data transferring unit 35d calculates the thin-out rate for each region grid square code (Step S106).

Then, the data transferring unit 35d refers to each pieces of the measurement data stored in the temporary storing unit 34a and specifies the total number of the calculated region grid square codes (n) (Step S107). Subsequently, the data transferring unit 35d attaches the variables l (1) to l (n) to each of the region grid square codes (Step S108).

Then, the data transferring unit 35d substitutes 1 for a variable (i) (Step S109) and reads the measurement data with the region grid square code that is associated with l (i) from the temporary storing unit 34a (Step S110). Subsequently, the data transferring unit 35d selects measurement data in accordance with the associated thin-out rate and then transfers the data to the quality information DB 50 (Step S111).

Then, the data transferring unit 35d increments the variable (i) (Step S112). If the incremented variable (i) is greater than the total number (n) of region grid square codes (Yes at Step S113), the data transferring unit 35d ends the process. In contrast, if the incremented variable (i) is smaller than the total number (n) of region grid square codes (No at Step S113), the data transferring unit 35d returns to Step S110 and repeatedly performs the process at Step S110 and the subsequent processes.

Processing Sequence

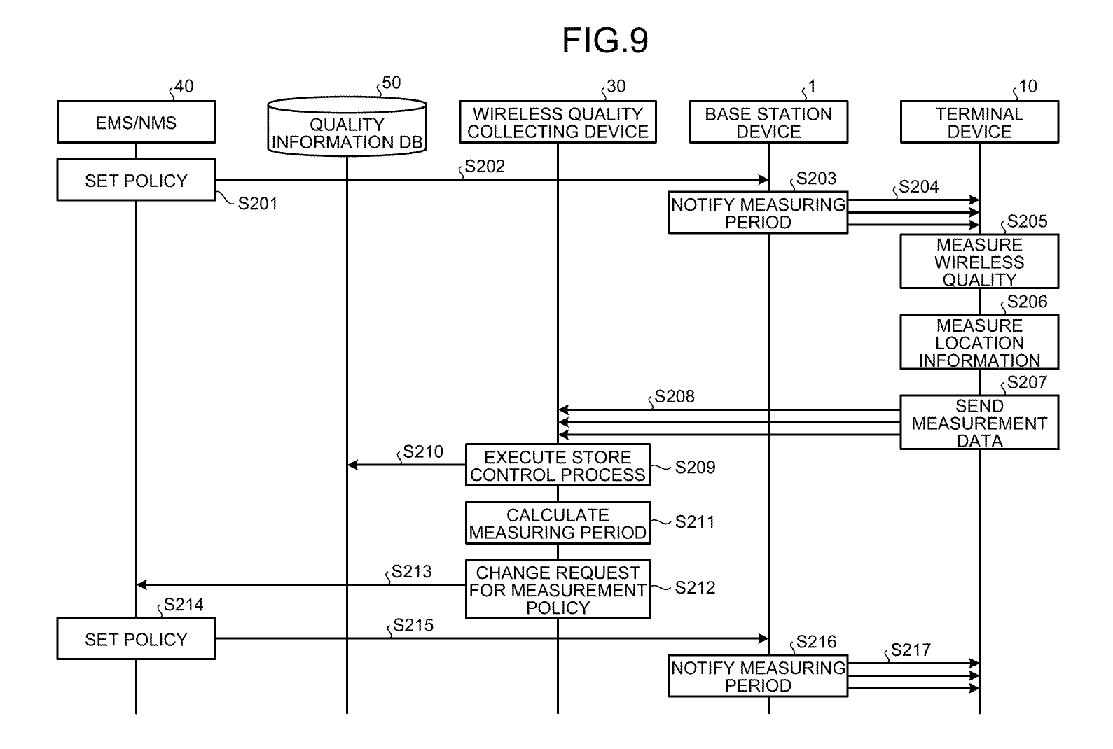

FIG. 9 is a processing sequence diagram of a process performed by a wireless communication system according to the first embodiment. As illustrated in FIG. 9, the EMS/NMS 40 sends a policy setting of a measuring period to each of the base station devices 1 (Steps S201 and S202). For example, the EMS/NMS 40 sends the initial value 10 (s) or the like to each of the base station devices 1.

The base station device 1 notifies each of the terminal devices 10 that are in a wireless area in which the base station device 1 can communicates the terminal devices 10 of the measuring period that is notified by the EMS/NMS 40 (Steps S203 and S204). When each of the terminal devices 10 measures the wireless quality in accordance with the notified measuring period (Step S205), each of the terminal devices 10 also measures location information (Step S206). When the measurement has been completed, each of the terminal devices 10 sends the measurement data to the wireless quality collecting device 30 via the base station device 1 (Steps S207 and S208).

When the wireless quality collecting device 30 receives the measurement data, the wireless quality collecting device 30 executes the store control process illustrated in FIG. 8, thins out some pieces of measurement data, and then stores data in the quality information DB 50 (Steps S209 and S210). Thereafter, the wireless quality collecting device 30 calculates a measuring period for each region grid square code by using the number of pieces of measurement data, a threshold, the current measuring period, or the like (Step S211). Then, the wireless quality collecting device 30 sends a change request for a new measurement policy to the EMS/NMS 40 (Steps S212 and S213). For example, the wireless quality collecting device 30 sends, to the EMS/NMS 40, the measuring period for each region grid square code that has newly been calculated.

Then, the EMS/NMS 40 sends, to each of the base station devices 1, a new measurement policy setting received as a notification (Steps S214 and S215). The base station device 1 notifies each of the terminal devices 10 in a wireless area in which the base station device 1 can communicate with the terminal devices 10 of the new measuring period that is notified by the EMS/NMS (steps S216 and S217). Then, the above processes repeatedly performed.

### Specific Example

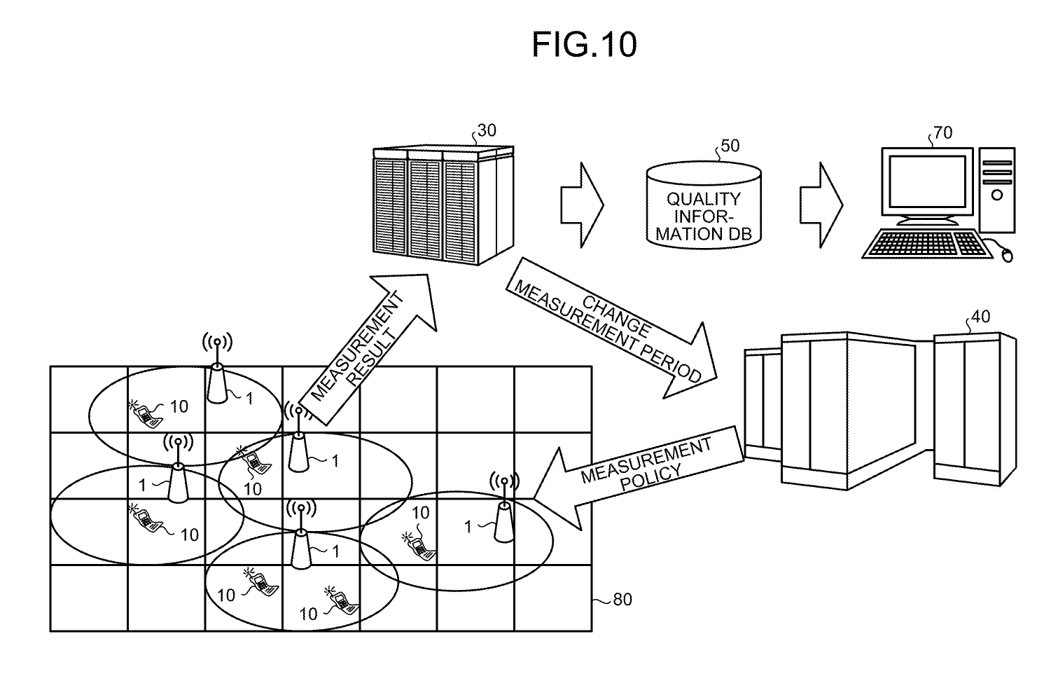

FIG. 10 is a schematic diagram illustrating a process performed by the wireless communication system according to the first embodiment. When each of the terminal devices 10 measures quality information on the wireless area to which the terminal devices 10 belongs, each of the terminal devices 10 sends the measurement data to the base station device 1 that manages the wireless area and then the base station device 1 sends the measurement data to the wireless quality collecting device 30.

The wireless quality collecting device 30 counts the number of pieces of measurement data for each region belonging to a predetermined range. For a region in which the total number of pieces of measurement data is equal to or greater than a predetermined number, the wireless quality collecting device 30 selects, from pieces of quality information belonging to the region, a predetermined number of pieces of the quality information and stores the quality information in the quality information DB 50. By doing so, it is possible to select some pieces of measurement data that are excessively collected due to the terminal devices 10 being concentrated and it is possible to store the selected measurement data in the quality information DB 50. Consequently, it is possible to reduce the storage capacity of the quality information DB 50, to reduce the waste of the network bandwidth between the wireless quality collecting device 30 and the quality information DB 50, and thus to suppress the capital investment in improving the wireless quality.

Furthermore, for the measurement data collected by the terminal device 10, the quality information DB 50 appropriately thins out overlapped measurement data and stores therein the remaining measurement data. Consequently, even when the number of pieces of measurement data used for improving the wireless quality is small, a quality analysis terminal 70 can suppress a decrease in the accuracy of the analysis.

The wireless quality collecting device 30 sets, by using the number of pieces of measurement data or the like, a new measurement policy such that a long measuring period is used in a region in which pieces of measurement data are concentrated and a short measuring period is used in a region in which the number of pieces of measurement data is small and then notifies the EMS/NMS 40 of the new measurement policy.

The EMS/NMS 40 notifies each of the base station devices 1 of the corresponding new measurement policy. Each of the base station devices 1 sends the notified measurement policy to the terminal device 10 that is managed by the corresponding base station device 1. This makes it possible to lengthen the collecting period of the measurement data in a region in which the terminal devices 10 are concentrated and to shorten the collecting period of the measurement data in a region in which the number of the terminal devices 10 is small.

Consequently, the wireless quality collecting device 30 can control a measuring period for each region in a region grid square 80; can prevent pieces of quality information overlapped in a specific region from being excessively collected; can collect an appropriate amount of wireless quality information; and use the collected information. Furthermore, it is possible to prevent the number of pieces of quality information collected by the terminal device 10 from being concentrated or from being insufficient in a specific region. Consequently, a company can suppress an excessive capital investment in a quality improvement task in a wireless area; can acquire an appropriate amount of data on the wireless quality; and thus can efficiently perform the task. Furthermore, because the measuring period for the terminal device 10 can be appropriately controlled, it is possible to suppress the waste of a network between the wireless quality collecting device 30 and each of the base station devices.

### [b] Second Embodiment

In the above explanation, a description has been given of the embodiment according to the present invention; however, the embodiment is not limited thereto and can be implemented with various kinds of embodiments other than the embodiments described above. Therefore, another embodiment will be described below.

Region Classification

In the first embodiment, a description has been given of an example in which a region grid square code is used for a method for classifying a region; however, the embodiment is not limited thereto. For example, a region may also be classified for each wireless area that is specified by the latitude and the longitude or may also be classified for each base station device that accommodates a wireless area.

System

Of the processes described in the embodiment, the whole or a part of the processes that are mentioned as being automatically performed can also be manually performed, or the whole or a part of the processes that are mentioned as being manually performed can also be automatically performed using known methods. Furthermore, the flow of the processes, the control procedures, the specific names, and the information containing various kinds of data or parameters indicated in the above specification and drawings can be arbitrarily changed unless otherwise stated.

The components of each unit illustrated in the drawings are only for conceptually illustrating the functions thereof and are not always physically configured as illustrated in the drawings. In other words, the specific shape of a separate or integrated device is not limited to the drawings. Specifically, all or part of the device can be configured by functionally or physically separating or integrating any of the units depending on various loads or use conditions. Furthermore, all or any part of the processing functions performed by each device can be implemented by a CPU and by programs analyzed and executed by the CPU or implemented as hardware by wired logic.

According to an aspect of the embodiment of the wireless quality collecting device, the wireless quality collecting method, and the wireless quality collecting program disclosed the present invention, an advantage is provided in that it is possible to suppress the capital investment in improving the wireless quality.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A wireless quality collecting device comprising:
a memory; and
a processor connected to the memory, wherein the processor executes a process comprising:
receiving quality information on a wireless area from a terminal device that is located in the wireless area;
counting, for each region belonging to a predetermined range, the number of pieces of the quality information received at the receiving; and
selecting, for a region in which the total number of pieces of the quality information counted at the counting is equal to or greater than a predetermined number, from among pieces of the quality information belonging to the region, the predetermined number of pieces of the quality information and storing, in the memory, the selected quality information.

2. The wireless quality collecting device according to claim 1, the process further comprises changing a period, for which pieces of the quality information are collected and sent and which is set in a terminal device located in the region in which the total number of pieces of the quality information is equal to or greater than the predetermined number, to a period that is longer than the period currently set.

3. The wireless quality collecting device according to claim 1, the process further comprises changing a period, for which pieces of the quality information are collected and sent and which is set in a terminal device located in a region in which the total number of pieces of the quality information is equal to or less than a predetermined set lower limit, to a period that is shorter than the period currently set.

4. The wireless quality collecting device according to claim 1, wherein the storing includes selecting, for the region in which the total number of pieces of the quality information is equal to or greater than the predetermined number, the quality information in the order pieces of the quality information are received at the receiving and at an interval of a value of an integer part of the result obtained by dividing the total number of pieces of the quality information by the predetermined number and storing the selected quality information in the memory.

5. A wireless quality collecting method comprising:
receiving quality information on a wireless area from a terminal device that is located in the wireless area, using a processor;
counting, for each region belonging to a predetermined range, the number of pieces of the received quality information, using the processor; and
selecting, for a region in which the total number of pieces of the counted quality information is equal to or greater than a predetermined number, from among pieces of the quality information belonging to the region, the predetermined number of pieces of the quality information and storing the selected quality information in a predetermined storing unit, using the processor.

6. A computer-readable recording medium having stored therein a wireless quality collecting program causing a computer to execute a process comprising:
receiving quality information on a wireless area from a terminal device that is located in the wireless area;
counting, for each region belonging to a predetermined range, the number of pieces of the received quality information; and
selecting, for a region in which the total number of pieces of the counted quality information is equal to or greater than a predetermined number, from among pieces of the quality information belonging to the region, the predetermined number of pieces of the quality information and storing the selected quality information in a predetermined storing unit.
